(19) United States
(12) Patent Application Publication
(10) Pub. No.: US 2004/0242211 A1
(43) Pub. Date: Dec. 2, 2004

(54) Mobile subscriber station with low frequency call alerting capability

(76) Inventors: A. Akhteruzzaman, Naperville, IL (US); Paul R. Sand, Woodridge, IL (US); Richard Grant Sparber, Wheaton, IL (US); Claudis L. Young, Aurora, IL (US)

Correspondence Address: PATTON BOGGS, 1660 LINCOLN ST, SUITE 2050, DENVER, CO, 80264, US

(21) Appl. No.: 10/448,562

(22) Filed: May 30, 2003

(51) Int. Cl. H04M 3/42

(52) U.S. Cl. 455/415; 455/414.1

(57) ABSTRACT

The callback mobile subscriber station is capable of receiving a numeric page when the callback mobile subscriber station is located in an area where regular cellular telephone service is unavailable, by receiving data on a low frequency channel that is capable of service in the subscriber's present location. The subscriber can then initiate a callback call to the calling party when they are in an active service area by simply activating the callback function on the callback mobile subscriber station. The callback mobile subscriber station stores the calling party's telephone number and automatically places a call to that number when the callback feature is activated. Alternatively, the subscriber can use a land-line based telephone to return the missed incoming call, even though there is no cellular service in their present location.

### FIELD OF THE INVENTION

This invention relates to cellular communications and, in particular, to a mobile subscriber station that provides wireless telephone services in conjunction with a low frequency call alerting capability.

### PROBLEM

It is a problem in the field of cellular mobile telephone services to provide customers with high quality communication services in a unified manner via a wireless communication medium. There are many instances when the subscriber is located in a place or in a mode where the mobile subscriber station cannot receive an incoming call. In these situations, the calling party must leave a voice mail message for the subscriber on their mobile subscriber station service and/or initiate another call connection to the subscriber's paging service (if the subscriber also has a pager) to leave a callback telephone number for the calling party.

In the instance where the mobile subscriber station is located in a no-service area, the subscriber does not receive any indication of the missed incoming call until their mobile subscriber station is in a location where it is again capable of receiving service. The subscriber must then call their voice mail service, retrieve the message and then initiate a call to the calling party by inputting the calling party's telephone number into the mobile subscriber station to initiate a call to the calling party. This process is laborious and subject to errors in the transfer of the calling party's telephone number from the voice mail system into the mobile subscriber station. In the instance where the subscriber is equipped with a pager, the subscriber must read the page and then input the telephone number received on the pager into the mobile subscriber station to initiate a call to the calling party. This process is laborious and subject to errors in the transfer of the calling party's telephone number from the paging system into the mobile subscriber station. This process also requires the subscriber to carry two different communication devices and to subscribe to two different communication services.

Thus, existing mobile subscriber stations are incapable of alerting a subscriber in real time of missed incoming calls and simultaneously storing calling party information in a queue while the mobile subscriber station is located in an area of no service.

### SOLUTION

The above-described problems are solved and a technical advance achieved in the field by the mobile subscriber station with low frequency call alerting capability, termed “callback mobile subscriber station” herein. The callback mobile subscriber station is capable of receiving a numeric page when the callback mobile subscriber station is located in an area where regular cellular telephone service is unavailable, by receiving data on a low frequency channel that is capable of service in the subscriber's present location. The subscriber can then initiate a callback call to the calling party when they are in an active service area by simply activating the callback function on the callback mobile subscriber station. The callback mobile subscriber station stores the calling party's telephone number and automatically places a call to that number when the callback feature is activated. Alternatively, the subscriber can use a land-line based telephone to return the missed incoming call, even though there is no cellular service in their present location.

The callback mobile subscriber station thereby functions as a pager to immediately provide the subscriber with incoming call information, even though the incoming call cannot be completed as well as an automatic dialer to initiate the callback call without the subscriber having to enter the calling party's telephone number once the subscriber is again in a location where regular cellular service is available.

### BRIEF DESCRIPTION OF THE DRAWINGS

FIG. 1 illustrates, in block diagram form, the overall architecture of a typical Mobile Telephone System;

FIG. 2 illustrates, in block diagram form, the architecture of a typical embodiment of the callback mobile subscriber station of the present invention; and

FIG. 3 illustrates, in flow diagram form, the operation of a typical embodiment of the callback mobile subscriber station of the present invention.

### DETAILED DESCRIPTION

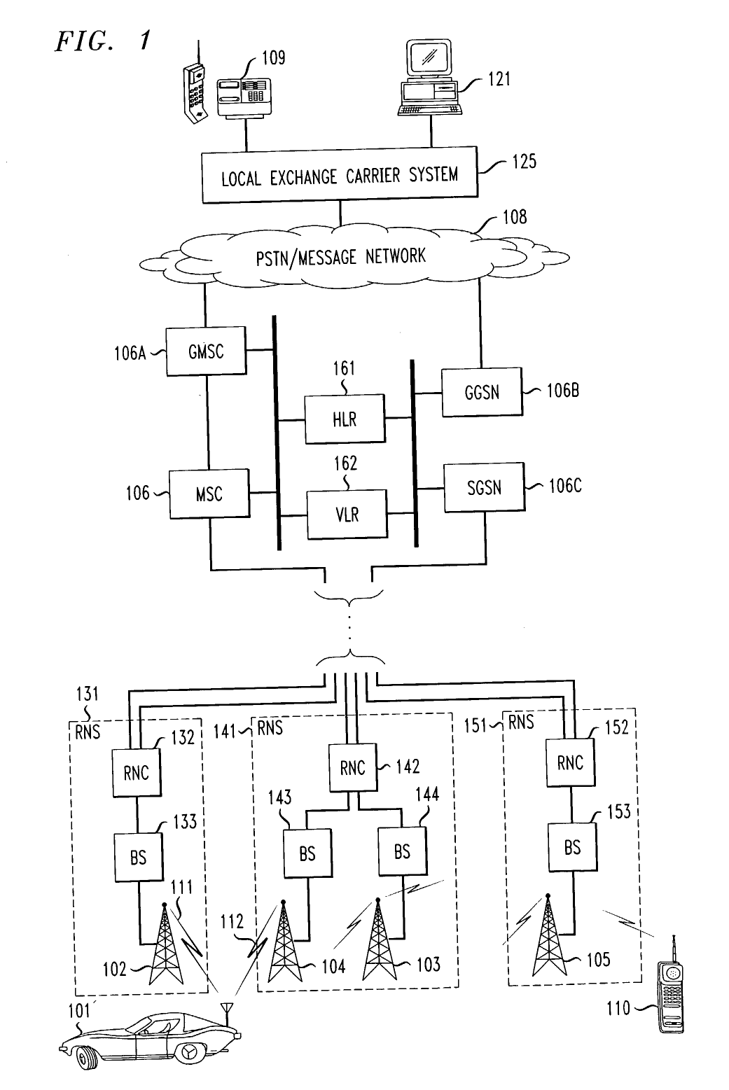

An example of a typical cellular communication network, as shown in block diagram form in FIG. 1, provides the service of connecting wireless telephone customers, each having a mobile subscriber station, to both land-based customers who are served by the Public Switched Telephone Network (PSTN) 108 as well as other wireless telephone customers. In such a network, all incoming and outgoing calls are routed through Mobile Switching Centers (MSC) 106, each of which is connected to a plurality of Radio Network Subsystems (RNS) 131-151 which communicate with mobile subscriber stations 101, 110 located in the area covered by the cell sites. The mobile subscriber stations 101, 110 are served by the Radio Network Subsystems (RNS) 131-151, each of which is located in one cell area of a larger service region. Each cell site in the service region is connected by a group of communication links to the Mobile Switching Center 106. Each cell site contains a group of radio transmitters and receivers, termed a “Base Station” (BS) herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station. The Mobile Switching Center 106, in conjunction with the Home Location Register (HLR) 161 and the Visitor Location Register (VLR) 162, manages subscriber registration, subscriber authentication, and the provision of wireless services such as voice mail, call forwarding, roaming validation and so on. The Mobile Switching Center 106 is connected to a Gateway Mobile Services Switching Center (GMSC) 106A as well as to the Radio Network Controllers RNC, with the GMSC 106A serving to interconnect the Mobile Switching Center 106 with the PSTN 108. In addition, the Radio Network Controllers are connected via Serving General Packet Radio Service (GPRS) Support Node (SGSN) 106C and thence the Gateway GPRS Support Node (GGSN) 106B to a network, for example the SS7 signaling network (Message Network 108). The Radio Network Controllers 132, 142, 152 control the transmitter-receiver pairs at the Base Station and the tuning of the mobile subscriber stations to the selected radio frequencies.

In FIG. 1, the mobile subscriber station 110 is simultaneously communicating with two Base Stations 133 & 143, thus constituting a soft handoff. However, a soft handoff is not limited to a maximum of two Base Stations. When in a soft handoff, the Base Stations serving a given call must act in concert so that commands issued over RF channels 111 and 112 are consistent with each other. In order to accomplish this consistency, one of the serving Base Stations may operate as the primary Base Station with respect to the other serving Base Stations. Of course, a mobile subscriber station 110 may communicate with only a single Base Station if this is determined to be sufficient by the cellular communication network.

The control channels that are available in this system are used to setup the communication connections between the mobile subscriber stations 110 and the Base Station 133. When a call is initiated, the control channel is used to communicate between the mobile subscriber station 110 involved in the call and the local serving Base Station 133. The control messages locate and identify the mobile subscriber station 110, determine the dialed number, and identify an available voice/data communication channel consisting of a pair of radio frequencies and orthogonal coding (as an example) which is selected by the Base Station 133 for the communication connection. The radio unit in the mobile subscriber station 110 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this mobile subscriber station 110 to an adjacent cell, when the subscriber moves from the present cell to one of the adjoining cells. The transmitter power of the mobile subscriber station 110 is regulated since the magnitude of the signal received at the Base Station 133 is a function of the mobile subscriber station transmitter power and the distance from the Base Station 133. Therefore, by scaling the transmitter power to correspond to the distance from the Base Station 133, the received signal magnitude at Base Station 133 can be maintained within a predetermined range of values to ensure accurate signal reception without interfering with other transmissions in the cell.

The voice communications between mobile subscriber station 110 and other subscriber stations, such as land line based subscriber station 109, is effected by routing the communications received from the mobile subscriber station 110 through the Mobile Switching Center 106 and trunks to the Public Switched Telephone Network (PSTN) 108 where the communications are routed to a Local Exchange Carrier 125 that serves land line based subscriber station 109. There are numerous Mobile Switching Centers 106 that are connected to the Public Switched Telephone Network (PSTN) 108 to thereby enable subscribers at both land line based subscriber stations and mobile subscriber stations to communicate between selected stations thereof. This architecture represents the present architecture of the wireless and wireline communication networks.

However, there are many instances when the subscriber is located in a place where the mobile subscriber station cannot receive an incoming call, such as inside of a building, in a remote location not provisioned with cellular service, and the like. In these situations, existing cellular communication systems detect the unavailability of the mobile subscriber station and transmit a message to the calling party indicating that the mobile subscriber station in not in communication with the cellular communication system. This situation requires that the calling party must leave a voice mail message for the subscriber on their mobile subscriber station service and/or initiate another call connection to the subscriber's paging service (if the subscriber also has a pager) to leave a callback telephone number for the subscriber to use to contact the calling party.

Callback Mobile Subscriber Station

In this environment, the callback mobile subscriber station overcomes the above-described problems since it is capable of receiving a numeric page when the callback mobile subscriber station is located in an area where regular cellular telephone service is unavailable, typically by receiving data on a low frequency channel that is capable of service in the subscriber's present location. The subscriber is then aware in real time of the incoming call attempt and can respond accordingly. The subscriber can initiate a callback call to the calling party when they are in an active service area by simply activating the callback function on the callback mobile subscriber station. The callback mobile subscriber station stores the calling party's telephone number and automatically places a call to that number when the callback feature is activated. The callback mobile subscriber station thereby functions as a pager to immediately provide the subscriber with incoming call information, even though the incoming call cannot be completed as well as an automatic dialer to initiate the callback call without the subscriber having to enter the calling party's telephone number. Alternatively, the subscriber can use a land-line based telephone to return the missed incoming call, even though there is no cellular service in their present location.

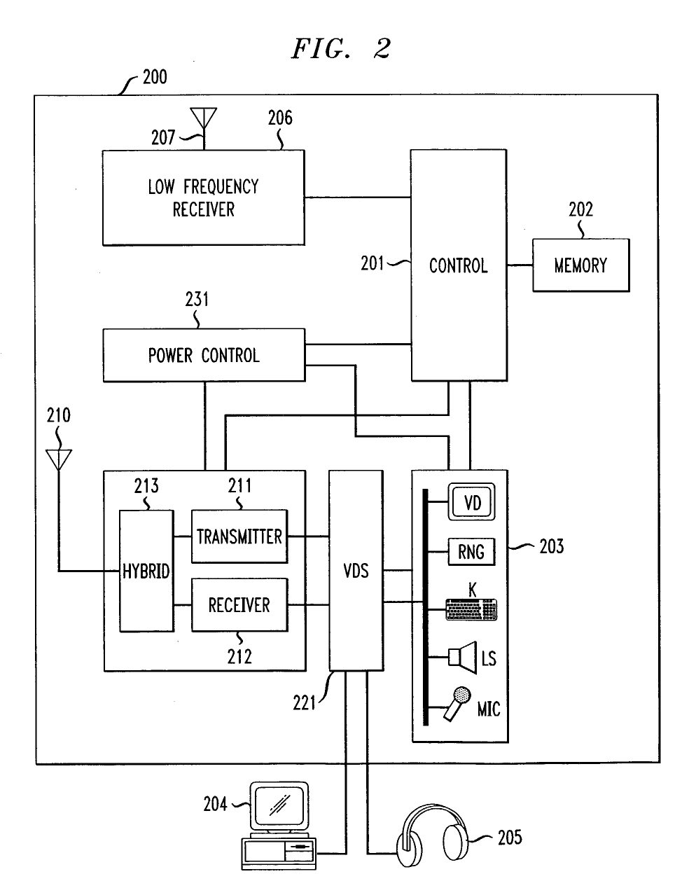

FIG. 2 illustrates, in block diagram form, the architecture of a typical embodiment of the callback mobile subscriber station 200 of the present invention. This particular embodiment of the callback mobile subscriber station 200 is disclosed to illustrate the concepts of the invention and is not intended to limit the application of the disclosed concepts. The callback mobile subscriber station 200 is equipped with a control 201 that operates pursuant to instructions that are stored in memory 202, as is described below.

The callback mobile subscriber station 200 is equipped with transmitter 211 and receiver 212 circuits well known in cellular communications for providing voice and data communications via a voice data switch 221. The apparatus also includes antenna 210, which is typically mounted on an exterior surface of the callback mobile subscriber station and coupled in well-known fashion to the transmitter 211 and receiver 212 circuits by a hybrid 213. The power output of the transmitter 211 can also be dynamically regulated as a function of the distance from the cell site transmitter antenna to ensure a relatively constant signal level at the Base Station for the received signals, using the Power Control circuit 231 presently available in many cellular radio systems.

The callback mobile subscriber station 200 includes a user interface 203 that is equipped with the apparatus necessary to enable the user to receive and input data. For example, the user interface 203 includes a display device VD that produces a human sensible visualization of the data that is received, audio output device LS to produce a human sensible audio output of the received data, and signaling device (such as a ringer) RNG. The user interface can also include audio input devices MIC and keyboard K (and/or mouse or pointer device) to enable the user to input data in an audible or textual form, respectively. In addition, the callback mobile subscriber station 200 can be connected to a headset 205, computing device 204 or other such apparatus, to enable the subscriber to use these ancillary devices for communication purposes.

The above-described elements are used in mobile subscriber stations and represent a universal set of communication hardware that performs the basic communication functions for exchanging data between the subscriber and the cell site of a cellular communication system. The protocols used in the processing of the communication signals received by the mobile subscriber station over the radio channel from the cell site and transmitted from the mobile subscriber station to the cell site, varies as a function of the Mobile Telephone System that presently serves the mobile subscriber station.

The callback mobile subscriber station 200 also contains a low frequency receiver 206 that is connected to both a low frequency antenna 207 (such as a ferrite stick antenna) and the control 201. The low frequency receiver 206 functions to receive pager-like signals from the Base Stations (or other low frequency transmitter) that identify the telephone number of a calling party. The low frequency receiver 206 stores the received telephone number or forwards the number to control 201. An incoming call received alert is generated by the control 201, ringer RNG may be activated, and an alert message is displayed to the subscriber on the display device VD to thereby enable the subscriber to be aware of the missed incoming call and the telephone number of the calling party. The subscriber can then subsequently initiate the callback process that automatically returns a call to the calling party using the stored calling party telephone number.

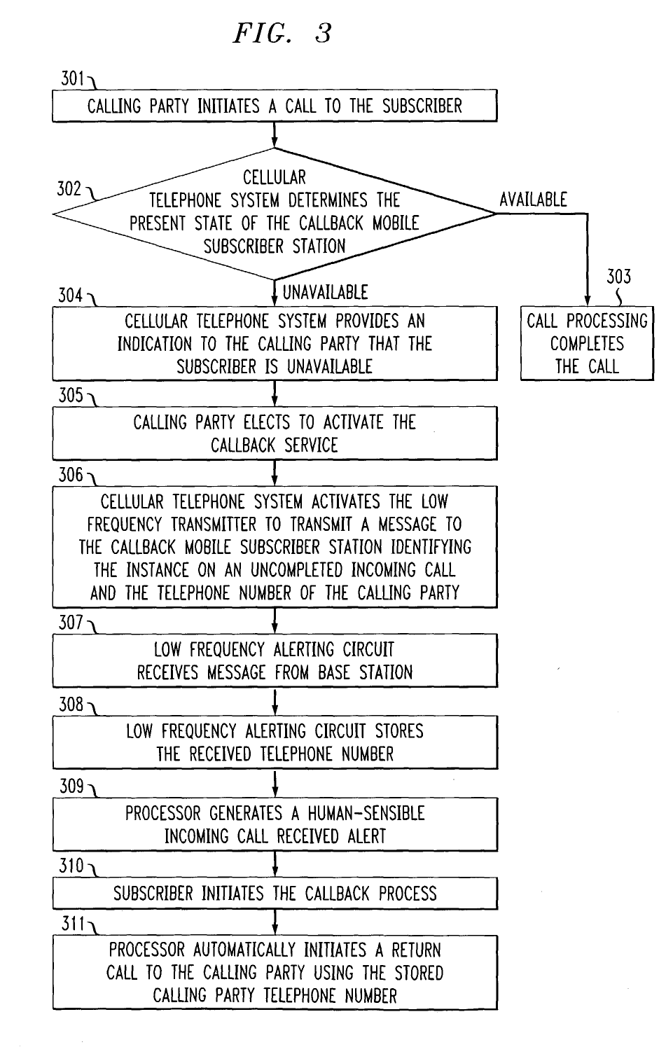

FIG. 3 illustrates, in flow diagram form, the operation of a typical embodiment of the callback mobile subscriber station 200 of the present invention. At step 301, a calling party initiates a call to the subscriber at callback mobile subscriber station 200. The serving cellular telephone system at step 302 determines the present state of the callback mobile subscriber station 200. If the callback mobile subscriber station 200 is idle and available, at step 303, call processing completes the call to the callback mobile subscriber station 200. If at step 302 it is determined that the callback mobile subscriber station 200 is unavailable to receive the call, which can be due to a number of reasons, such as: the callback mobile subscriber station 200 being switched off, or by the callback mobile subscriber station 200 being in a no-service area, or the callback mobile subscriber station 200 being engaged in an existing call connection, or the callback mobile subscriber station 200 not answering the call, then the cellular telephone system provides, at step 304, an indication to the calling party that the subscriber is unavailable to receive the call. At step 305, the calling party can elect to activate the callback service (or it may be automatically activated) to leave their telephone number with the subscriber on the callback mobile subscriber station 200, using the low frequency alerting capability of the callback mobile subscriber station 200. At step 306, the cellular telephone system activates the base station (or associated low frequency transmitter) that had last been serving the callback mobile subscriber station 200 to transmit a message to the callback mobile subscriber station 200 identifying the instance on an uncompleted incoming call and the telephone number of the calling party. The cellular telephone system typically does not know the present location of the callback mobile subscriber station 200 if it is in a no-service area, so the transmission of the low frequency alert can be addressed in a number of manners. As noted, the last serving base station can transmit the low frequency alert, and the coverage area of this signal is typically greater than the coverage area of the standard voice channel transmission of the base station, so there is a greater likelihood of reaching the callback mobile subscriber station 200. Alternatively, the cellular telephone system can activate a wider coverage area transmission for the low frequency alert, that encompasses the last serving base station and the base stations located within a predetermined radius of that site (which radius can be determined as a function of the length of time the callback mobile subscriber station 200 has been unavailable), or can provide a regional transmission of the low frequency alert.

The low frequency receiver 206 at step 307 receives the message from the base station, identifying the instance of an uncompleted incoming call and the telephone number of the calling party, and stores the received telephone number or forwards the number to control 201 for storage at step 308. The receipt of the message is predicated on the availability of a low frequency communication channel between the cellular telephone system and the callback mobile subscriber station 200. In the instance where the callback mobile subscriber station 200 is temporarily in a no-service area, or busy, or not answering, the presently serving Base Station can be used as the message origination point for the low frequency alert. Where the callback mobile subscriber station 200 is powered down or in a no-service area, the identity of the presently serving Base Station is determined only when the callback mobile subscriber station 200 is activated and initiates the network presence routine. It that case, the callback information is queued in the cellular telephone network for delivery to the callback mobile subscriber station 200 when the callback mobile subscriber station 200 becomes active on the cellular telephone network. Then the data identifying the queue of missed incoming calls can be transmitted to the callback mobile subscriber station 200.

In response to receipt of the callback message from the Base Station, the control 201 generates a human-sensible incoming call received alert at step 309 and transmits the alert to the subscriber on an output device, such as the display device VD, and/or the ringer RNG or audio output device LS, or the like. This incoming call received alert provides sufficient data to the subscriber to enable the subscriber to screen the incoming call and also enables the subscriber, if they so desire, to initiate the callback process at step 310, wherein the control 201 automatically initiates a return call to the calling party at step 311 using the stored calling party telephone number. The subscriber does not have to input the telephone number of the calling party, the control 201 simply retrieves this information from the stored callback message and uses it to initiate an outgoing call from callback mobile subscriber station 200 to the calling party.

Loss of Call Connection

In the case where the subscriber is on an existing call connection and enters an area where service is unavailable, the above-described system functions to store the telephone number of the party to whom the subscriber was connected for reconnection purposes. In particular, where the subscriber is on an existing call connection with a “calling party” and looses the cellular signal, the serving cellular telephone system at step 302 determines the present state of the callback mobile subscriber station 200. Since in this example, the callback mobile subscriber station 200 is unavailable to receive the call due to the callback mobile subscriber station 200 being in a no-service area, then the cellular telephone system provides at step 304 an indication to the calling party that the subscriber is presently unavailable. At step 305, the subscriber can elect to activate the callback service (or it may be automatically activated) to leave their telephone number with the subscriber on the callback mobile subscriber station 200. At step 306, the cellular telephone system activates the base station (or associated low frequency transmitter) that is presently serving the callback mobile subscriber station 200 to transmit a message to the callback mobile subscriber station 200 identifying the instance on an interrupted call and the telephone number of the calling party.

The low frequency receiver 206 at step 307 receives the message from the base station, identifying the instance of an interrupted call and the telephone number of the calling party, and stores the received telephone number or forwards the number to control 201 for storage at step 308. The receipt of the message is predicated on the availability of a communication channel between the cellular telephone system and the callback mobile subscriber station 200. In the instance where the callback mobile subscriber station 200 is temporarily in a no-service area, the presently serving Base Station can be used as the message origination point.

In response to receipt of the callback message from the Base Station, the control 201 generates a human-sensible incoming call received alert at step 309 and transmits the alert to the subscriber on an output device, such as the display device VD, and/or the audio output device LS, or ringer RNG, or the like. This lost call alert provides sufficient data to the subscriber to enable the subscriber to initiate the callback process at step 310 when the subscriber is again in an active service area, wherein the control 201 automatically initiates a return call to the calling party at step 311 using the stored calling party telephone number. The subscriber does not have to input the telephone number of the calling party, the control 201 simply retrieves this information from the stored callback message and uses it to initiate an outgoing call from callback mobile subscriber station 200 to the calling party.

### SUMMARY

The callback mobile subscriber station is capable of receiving a numeric page when the callback mobile subscriber station is located in an area where regular cellular telephone service is unavailable, typically by receiving data on a low frequency channel that is capable of service in the subscriber's present location. The subscriber can then initiate a callback call to the calling party when they are in an active service area by simply activating the callback function on the callback mobile subscriber station.

What is claimed:

1. A callback mobile subscriber station, operable to enable a subscriber to automatically be alerted of the receipt of an uncompleted incoming call from a calling party in response to receipt of a callback message from a cell site of a cellular communication system, comprising:
transmitter/receiver means for communicating with a cell site of a cellular communication system via communication signals carried on a predetermined cellular radio frequency;
means for converting between said communication signals carried on said predetermined cellular radio frequency and subscriber data to exchange data between said subscriber and said cell site of a cellular communication system; and
means for receiving data, transmitted on a callback radio frequency other than said predetermined cellular radio frequency, indicative of receipt of an uncompleted incoming call from a calling party.

2. The callback mobile subscriber station of claim 1 wherein said means for receiving data comprises:
means for receiving radio frequency signals at said callback radio frequency that is lower in frequency than said predetermined cellular radio frequency.

3. The callback mobile subscriber station of claim 1 wherein said means for receiving data comprises:
means for storing data in a memory, indicative of a telephone number for said calling party, received in said callback radio frequency signals.

4. The callback mobile subscriber station of claim 3 wherein said means for receiving data further comprises:
means for generating a human-sensible alert, indicative of receipt of an incoming call from said calling party.

5. The callback mobile subscriber station of claim 4 wherein said means for receiving data further comprises:
means for displaying data to said subscriber, indicative of an option to activate a callback process.

6. The callback mobile subscriber station of claim 3 wherein said means for automatically establishing a communication connection comprises:
means, responsive to a subscriber initiating a callback process, for retrieving said data stored in said memory, indicative of a telephone number for said calling party; and
means for initiating a communication connection to said telephone number using said transmitter/receiver means.

7. A method of providing a callback service in a mobile subscriber station, to automatically alert a subscriber of the receipt of an uncompleted incoming call from a calling party in response to receipt of a callback message from a cell site of a cellular communication system, comprising:
communicating with a cell site of a cellular communication system via communication signals carried on a predetermined cellular radio frequency;
converting between said communication signals carried on said predetermined cellular radio frequency and subscriber data to exchange data between said subscriber and said cell site of a cellular communication system; and
receiving data, transmitted on a callback radio frequency other than said predetermined cellular radio frequency, indicative of receipt of an uncompleted incoming call from a calling party.

8. The method of providing a callback service in a mobile subscriber station of claim 7 wherein said step of receiving data comprises:
receiving radio frequency signals at said callback radio frequency that is lower in frequency than said predetermined cellular radio frequency.

9. The method of providing a callback service in a mobile subscriber station of claim 7 wherein said step of receiving data comprises:
storing data in a memory, indicative of a telephone number for said calling party, received in said callback radio frequency signals.

10. The method of providing a callback service in a mobile subscriber station of claim 9 wherein said step of receiving data further comprises:
generating a human-sensible alert, indicative of receipt of an incoming call from said calling party.

11. The method of providing a callback service in a mobile subscriber station of claim 10 wherein said step of receiving data further comprises:
displaying data to said subscriber, indicative of an option to activate a callback process.

12. The method of providing a callback service in a mobile subscriber station of claim 9 wherein said step of automatically establishing a communication connection comprises:
retrieving, in response to a subscriber initiating a callback process, said data stored in said memory, indicative of a telephone number for said calling party; and
initiating a communication connection to said telephone number using said transmitter/receiver.
